(19) United States
(12) Patent Application Publication
(10) Pub. No.: US 2025/0167210 A1
(43) Pub. Date: May 22, 2025

(54) ELECTRODE ACTIVE MATERIAL LAYER, SOLID-STATE BATTERY, AND PRODUCTION METHOD FOR ELECTRODE ACTIVE MATERIAL LAYER

(71) Applicants: TOYOTA JIDOSHA KABUSHIKI KAISHA, Toyota-shi (JP); Panasonic Holdings Corporation, Osaka (JP)

(72) Inventors: Aiko NAGANO, Nisshin-shi (JP); Yasutaka TSUTSUI, Osaka-shi (JP); Izuru SASAKI, Kyoto-shi (JP)

(73) Assignees: TOYOTA JIDOSHA KABUSHIKI KAISHA, Toyota-shi (JP); Panasonic Holdings Corporation, Osaka (JP)

(21) Appl. No.: 18/944,415

(22) Filed: Nov. 12, 2024

(30) Foreign Application Priority Data
Nov. 17, 2023 (JP) 2023-195981

(51) Int. Cl. H01M 4/139; H01M 4/62; H01M 10/0585

(52) U.S. Cl. CPC H01M 4/139; H01M 4/622; H01M 10/0585

(57) ABSTRACT

An electrode active material layer in the present disclosure contains an electrode active material and a binder, and the ratio of a binder area fraction of a solid electrolyte layer side to a binder area fraction of a current collector side is 55 area % or more. A solid-state battery in the present disclosure includes a current collector, the electrode active material layer in the present disclosure, and a solid electrolyte layer, in this order. A method in the present disclosure for producing the electrode active material layer includes (a) providing an electrode composite material slurry containing the binder and others, (b) forming a preparatory electrode active material layer by coating the current collector with the slurry, (c) drying the preparatory electrode active material layer at a temperature lower than 100° C., and (d) further drying the dried preparatory electrode active material layer at a temperature of 140° C. or higher.

### CROSS-REFERENCE TO RELATED APPLICATION

This application claims priority to Japanese Patent Application No. 2023-195981 filed on Nov. 17, 2023. The disclosure of the above-identified application, including the specification, drawings, and claims, is incorporated by reference herein in its entirety.

### BACKGROUND

### 1. Technical Field

The present disclosure relates to an electrode active material layer, a solid-state battery, and a production method for the electrode active material layer.

### 2. Description of Related Art

As disclosed in Japanese Unexamined Patent Application Publication No. 2021-131988, a method of producing a negative electrode active material layer by coating a surface of a current collecting foil with a negative electrode mixture coating material (negative electrode composite material slurry) and drying the negative electrode mixture coating material is known.

### SUMMARY

In a solid-state battery, from a standpoint of production cost, it is preferable to form a solid electrolyte layer on an electrolyte active material layer by coating the electrode active material layer with a solid electrolyte slurry. However, in the case of a conventional electrode active material layer, when the solid electrolyte layer is formed by coating the electrode active material layer with the solid electrolyte slurry, peeling sometimes occurs between the obtained electrode active material layer and the solid electrolyte layer.

The present disclosure has an object to provide an electrode active material layer that can be formed on a solid electrolyte layer by coating with a solid electrolyte slurry, a solid-state battery that includes the electrode active material layer, and a production method for the electrode active material layer.

The discloser and others have found that the above problem can be solved by the following means.

### <Aspect 1>

An electrode active material layer for a solid-state battery, the electrode active material layer being interposed between a current collector and a solid electrolyte layer,
the electrode active material layer containing an electrode active material and a binder, wherein
a ratio of a binder area fraction of a side of the solid electrolyte layer to a binder area fraction of a side of the current collector is 55 area % or more.

### <Aspect 2>

The electrode active material layer according to aspect 1, wherein a ratio of the binder area fraction of the side of the solid electrolyte layer to a binder volume fraction is 30% or more.

### <Aspect 3>

The electrode active material layer according to aspect 1 or 2, wherein the binder is a styrene-butadiene rubber binder.

<Aspect 4>

A solid-state battery comprising:
a current collector;
a solid electrolyte layer; and
the electrode active material layer according to any one of aspects 1 to 3, the electrode active material layer being interposed between the current collector and the solid electrolyte layer.

### <Aspect 5>

A production method for the electrode active material layer according to any one of aspects 1 to 3, the production method comprising:
(a) providing an electrode composite material slurry that contains the electrode active material, the binder, and a dispersion medium;
(b) forming a preparatory electrode active material layer by coating the current collector with the slurry;
(c) drying the preparatory electrode active material layer at a temperature lower than 100° C.; and
(d) further drying the preparatory electrode active material layer dried at the temperature lower than 100° C., at a temperature of 140° C. or higher.

The present disclosure makes it possible to provide an electrode active material layer that can be formed on a solid electrolyte layer by coating with a solid electrolyte slurry, a solid-state battery that includes the electrode active material layer, and a production method for the electrode active material layer.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view showing an exemplary solid-state battery in the present disclosure;

FIG. 2 is a graph showing a binder area fraction of a solid electrolyte layer side and a binder area fraction of a current collector side about electrode active material layers in a comparative example 2 and examples 1 and 2;

FIG. 3A is a SEM image of the electrode active material layer in the comparative example 2 that is photographed from the solid electrolyte layer side;

FIG. 3B is a SEM image of the electrode active material layer in the example 1 that is photographed from the solid electrolyte layer side;

FIG. 3C is a SEM image of the electrode active material layer in the example 2 that is photographed from the solid electrolyte layer side;

FIG. 4A is a binarized image of a SEM image of the electrode active material layer in the comparative example 2 that is photographed from the solid electrolyte layer side; and

FIG. 4B is a binarized image of a SEM image of the electrode active material layer in the example 2 that is photographed from the solid electrolyte layer side.

### DETAILED DESCRIPTION OF EMBODIMENTS

An embodiment of the present disclosure will be described below in detail. The present disclosure is not limited to the embodiment described below, and can be carried out while being variously modified within the scope of the spirit of the present disclosure.

### Electrode Active Material Layer

An electrode active material layer in the present disclosure is an electrode active material layer for a solid-state battery that is interposed between a current collector and a solid electrolyte layer. The electrode active material layer in the present disclosure contains an electrode active material and a binder, and the ratio of a binder area fraction of the solid electrolyte layer side to a binder area fraction of the current collector side is 55 area % or more.

Generally, the electrode active material layer is formed by coating the current collector with an electrode composite material slurry and drying the electrode composite material slurry.

In this regard, the discloser and others have found the following points.
On the current collector side of the electrode active material layer, the binder spreads on the interface between the electrode active material layer and the current collector, and suitably joins the electrode active material layer and the current collector.
On the other hand, on the solid electrolyte layer side of the electrode active material layer that is exposed at the time of the drying of the electrode active material layer, the binder does not spread on the electrode active material layer, and exists in a grain form.
When the electrode active material layer in such a state is coated with a solid electrolyte slurry and the solid electrolyte layer is formed on the electrode active material layer, the binder does not sufficiently spread between the electrode active material layer and the solid electrolyte layer, and the joining between the electrode active material layer and the solid electrolyte layer becomes unsuitable, so that peeling can occur between the electrode active material layer and the solid electrolyte layer.

Further, based on the above knowledge, the discloser and others have found that it is possible to suitably form the solid electrolyte layer on the electrode active material layer when the electrode active material layer is coated with the solid electrolyte slurry, by causing the binder to sufficiently spread on the electrode active material layer.

Furthermore, the discloser and others have found that it is possible to produce an electrode active material layer in which the binder sufficiently spreads on the electrode active material layer, by drying a preparatory electrode active material layer at a low temperature and further drying the preparatory electrode active material layer dried at the low temperature, at a high temperature. The reason is estimated as follows, although the restraint by any theory is not intended. By drying an electrode composite material slurry at a low temperature, it is possible to obtain a flat preparatory electrode active material layer on which it is hard for a crack to be generated. Thereafter, by further drying the preparatory electrode active material layer at a high temperature, the viscosity of the binder decreases, and the binder sufficiently spreads on the electrode active material layer.

In the present disclosure, the “electrode composite material” means a composition that can compose the electrode active material layer just as it is or by further containing another component. Further, in the present disclosure, the “electrode composite material slurry” means a slurry that contains a dispersion medium in addition to the “electrode composite material” and thereby can form the electrode active material layer by application and drying.

The electrode active material layer in the present disclosure is interposed between the current collector and the solid electrolyte layer.

The electrode active material layer in the present disclosure contains an electrode active material and a binder, and optionally contains a solid electrolyte and a conduction aid.

### Electrode Active Material

The electrode active material is not particularly limited, as long as the use as the electrode active material of a battery is possible. Accordingly, the electrode active material may be a positive electrode active material, or may be a negative electrode active material. Particularly, the electrode active material in the present disclosure may be the negative electrode active material. Two substances different in the electric potential (charge and discharge potential) for the storage and release of a predetermined ion are selected from known electrode active materials. The substance having a noble potential can be used as the positive electrode active material, and the substance having a base potential can be used as the negative electrode active material.

As the positive electrode active material, a known active material may be used. For example, in the case of a lithium-ion battery, various lithium-containing complex oxides such as lithium cobalt oxide, lithium nickelate, LiNi_{1/3}Co_{1/3}Mn_{1/3}O₂, lithium manganate, and a spinel-type lithium compound can be used as the positive electrode active material. Further, lithium ferrous phosphate (LFP) can be used as an olivine-type positive electrode active material. The positive electrode active material may have a particle form, for example, and the size is not particularly limited.

As the negative electrode active material, a known active material may be used. For example, in the case of the lithium-ion battery, a silicon active material such as silicon, a silicon alloy, and silicon oxide; a carbon active material such as graphite and hard carbon; various oxide active materials such as lithium titanate, a metal lithium, a lithium alloy, and the like can be used as the negative electrode active material. The negative electrode active material may have a particle form, for example, and the size is not particularly limited.

### Binder

The binder is not particularly limited, as long as the binder is ordinarily used as the binder of the electrode active material layer. Examples of the binder may include materials such as polyvinylidene fluoride-hexafluoropropylene copolymer (PVDF-co-HEP), polyvinylidene fluoride (PVDF), polytetrafluoroethylene (PTFE), polyacrylic acid, polyacrylonitrile, polymethyl methacrylate, polyvinyl alcohol, polyvinyl pyrrolidone, carboxymethyl cellulose (CMC), hydroxypropyl cellulose, regenerated cellulose, polyethylene, polypropylene, starch, butadiene rubber (BR), styrene-butadiene rubber (SBR), and fluororubber, or a combination of the materials, but is not limited to them. Particularly, the binder may be in a colloid particle state.

### Binder Area Fraction

The binder area fraction of the solid electrolyte layer side, that is, the ratio of the binder area of the solid electrolyte layer side of the electrolyte active material layer to the total area of the solid electrolyte layer side of the electrode active material layer may be 0.45 area % or more, 0.50 area % or more, 0.55 area % or more, 0.60 area % or more, 0.65 area % or more, 0.70 area % or more, 0.75 area % or more, or 0.80 area % or more, and may be 1.20 area % or less, 1.10 area % or less, or 1.00 area % or less. Since the binder area fraction of the solid electrolyte layer side is in the above range, the binder suitably spreads on the solid electrolyte layer side of the electrode active material layer, so that it is hard for peeling to occur between the electrode active material layer and the solid electrolyte layer. Further, since the binder area fraction of the solid electrolyte layer side is in the above range, it is possible to avoid the binder from excessively interfering with the ion conduction between the electrode active material layer and the solid electrolyte layer.

The ratio of the binder area fraction of the solid electrolyte layer side to the binder area fraction of the current collector side is 55 area % or more. This ratio may be 56 area % or more, 57 area % or more, 58 area % or more, 59 area % or more, or 60 area % or more, and may be 150 area % or less, 120 area % or less, 110 area % or less, 100 area % or less, 95 area % or less, or 90 area % or less. As this ratio is closer to 100 area %, the difference in the degree of the spread of the binder between the solid electrolyte layer side and current collector side of the electrode active material layer is smaller.

In the present disclosure, the “binder area fraction” means the ratio of the area of the binder on a planar image acquired by a scanning electron microscope (SEM). The binder area fraction of the solid electrolyte layer side can be calculated, for example, by observing a SEM image of the surface of the electrode active material layer formed on the current collector. Further, the binder area fraction of the current collector side can be calculated, for example, by peeling the electrode active material layer from the current collector using a tape or the like and observing a SEM image of the surface of the electrode active material layer on the current collector contact side.

Specifically, for example, the binder area fraction of the solid electrolyte layer side and the binder area fraction of the current collector side can be calculated by the following method. First, an acquired SEM image is captured and quantified by image processing software (ImageJ). Digital image data has a matrix form corresponding to the SEM image of the electrode active material layer, and a numerical value is assigned to each pixel. The numerical value is shown as a tonal scale of 256, which is the eighth power of 2, for an 8-bit display, and is an integer value of 0 to 255. The numerical value is binarized by adopting 220 as a threshold. That is, it is determined that a white portion is the binder, portions other than the binder are expressed as “0”, and the binder is expressed as “1”. Then, the ratio of portions on the binarized image that are expressed as “1” to the whole image is evaluated, and thereby, the binder area fraction can be calculated. This analysis is executed for both of the solid electrolyte layer side and the current collector side of the electrode active material layer, and the calculated binder area fraction of the solid electrolyte layer side is divided by the binder area fraction of the current collector side. Thereby, the ratio of the binder area fraction of the solid electrolyte layer side to the binder area fraction of the current collector side can be calculated. Each binder area fraction may be an average value that is calculated from images acquired at a plurality of different portions on the surface of the electrode active material layer.

The ratio of the binder area fraction (area %) of the solid electrolyte layer side to a binder volume fraction (volume %) may be 25% or more. This ratio may be 26% or more, 27% or more, 28% or more, 29% or more, or 30% or more, and may be 60% or less, 55% or less, 53% or less, 52% or less, 51% or less, or 50% or less. Since this ratio is in the above range, the binder suitably spreads on the solid electrolyte layer side of the electrolyte active material layer, so that it is hard for peeling to occur between the electrode active material layer and the solid electrolyte layer.

### Binder Volume Fraction

The ratio of the binder volume to the total of the volumes of components contained in the electrode active material layer, that is, the binder volume fraction may be 0.1 volume % or more, 0.5 volume % or more, 1.0 volume % or more, 1.5 volume % or more, or 2.0 volume % or more, and may be 5.0 volume % or less, 4.0 volume % or less, 3.0 volume % or less, or 2.5 volume % or less.

### Solid Electrolyte and Conduction Aid

The solid electrolyte and the conduction aid are not particularly limited, and may be a solid electrolyte and a conduction aid that are ordinarily used for the electrode active material layer of the battery.

### Production Method for Electrode Active Material Layer

A method in the present disclosure for producing the electrode active material layer includes (a) providing an electrode composite material slurry that contains the electrode active material, the binder, and the dispersion medium, (b) forming a preparatory electrode active material layer by coating the current collector with the slurry, (c) drying the preparatory electrode active material layer at a temperature lower than 100° C., and (d) further drying the preparatory electrode active material layer dried at the temperature lower than 100° C., at a temperature of 140° C. or higher.

### Electrode Composite Material Slurry Providing Step

The method in the present disclosure includes (a) providing an electrode composite material slurry that contains the electrode active material, the binder, and the dispersion medium. The method for providing the electrode composite material slurry is a method of stirring and mixing the components, for example, but is not limited to this.

### Preparatory Electrode Active Material Layer Forming Step

The method in the present disclosure includes (b) forming a preparatory electrode active material layer by coating the current collector with the slurry. The method for coating the current collector with the slurry is a method such as die coating and blade coating, for example, but is not limited to this.

### First Drying Step

The method in the present disclosure includes (c) drying the preparatory electrode active material layer at a temperature lower than 100° C. The drying temperature may be 40° C. or higher, 50° C. or higher, 55° C. or higher, or 60° C. or higher, and may be 90° C. or lower, 80° C. or lower, 70° C. or lower, or 65° C. or lower. By drying the preparatory electrode active material layer at a low temperature in this way, it is possible to obtain a flat film on which it is hard for a crack to be generated. The drying time in this step may be appropriately designed depending on the content and boiling point of the dispersion medium, and the like. For example, the drying time may be 10 seconds or more, 20 seconds or more, 30 seconds or more, 40 seconds or more, 50 seconds or more, or 1 minute or more, and may be 5 minutes or less, 4 minutes or less, 3 minutes or less, or 2 minutes or less.

The method in the present disclosure may include drying the preparatory electrode active material layer at a temperature that is 100° C. or higher and is lower than 140° C., after step (c) and before step (d). Further, this temperature may be 105° C. or higher, 110° C. or higher, 115° C. or higher, or 120° C. of higher, and may be 135° C. or lower, 130° C. or lower, or 125° C. or lower. By further drying the preparatory electrode active material layer at such a temperature, it is possible to efficiently obtain a flat film on which it is hard for a crack to be generated. The drying time in this step may be appropriately designed depending on the content and boiling point of the dispersion medium, and the like. For example, the drying time may be 10 seconds or more, 20 seconds or more, 30 seconds or more, 40 seconds or more, 50 seconds or more, or 1 minute or more, and may be 5 minutes or less, 4 minutes or less, 3 minutes or less, or 2 minutes or less.

### Second Drying Step

The method in the present disclosure includes (d) further drying the preparatory electrode active material layer dried at the temperature lower than 100° C., at a temperature of 140° C. or higher. This temperature may be 145° C. or higher, 150° C. or higher, 160° C. or higher, or 165° C. or higher, and may be 200° C. or lower, 190° C. or lower, 180° C. or lower, 175° C. or lower, or 170° C. or lower. By further drying the preparatory electrode active material layer at such a temperature, the binder on the solid electrolyte layer side of the electrode active material layer easily spreads. The drying time in this step may be appropriately designed depending on the content and boiling point of the dispersion medium, and the like. For example, the drying time may be 10 seconds or more, 20 seconds or more, 30 seconds or more, 40 seconds or more, 50 seconds or more, or 1 minute or more, and may be 5 minutes or less, 4 minutes or less, 3 minutes or less, or 2 minutes or less.

The electrode active material layer in the present disclosure is an electrode active material layer for a solid-state battery that includes a negative electrode current collector and a solid electrolyte layer.

### Solid-State Battery

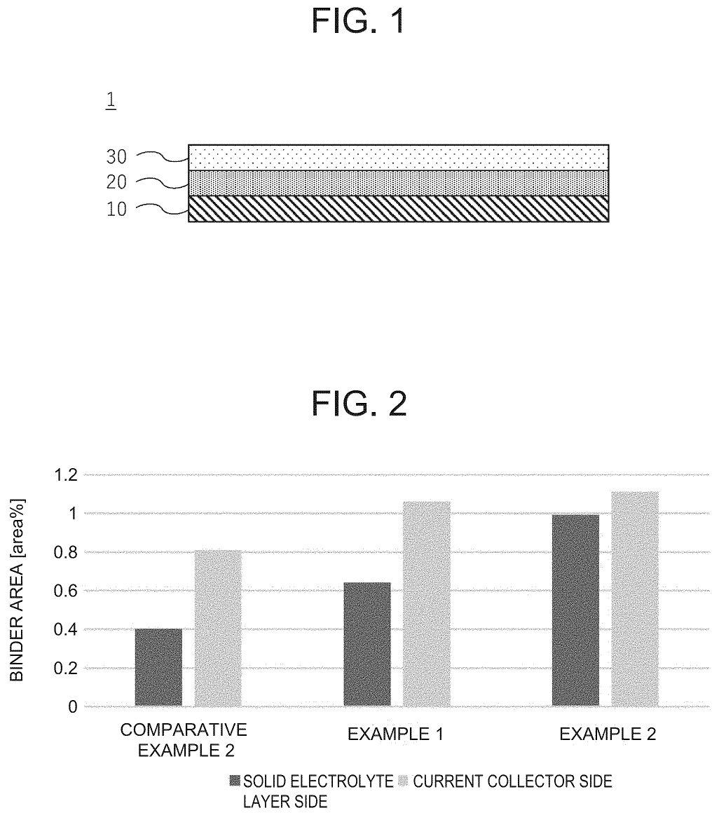

As shown in shown in FIG. 1, a solid-state battery 1 in the present disclosure includes a current collector 10, an electrode active material layer 20 in the present disclosure, and a solid electrolyte layer 30, in this order. Particularly, the electrode active material layer in the present disclosure may be a negative electrode active material, and in this case, the solid-state battery in the present disclosure may include a negative electrode current collector, the electrode active material layer in the present disclosure as the negative electrode active material layer, the solid electrolyte layer, a positive electrode active material layer, and a positive electrode current collector, in this order. The dimension relation in FIG. 1 does not reflect the actual dimension relation.

In the present disclosure, the “solid-state battery” means a battery in which at least a solid electrolyte is used as the electrolyte, and accordingly, in the solid-state battery, a combination of a solid electrolyte and a liquid electrolyte may be used as the electrolyte. Further, the solid-state battery in the present disclosure may be an all-solid-state battery, that is, a battery in which only the solid electrolyte is used as the electrolyte.

The positive electrode current collector and the negative electrode current collector are not particularly limited, as long as the use as the current collector of the battery is possible. For example, in the case of the lithium-ion battery, an aluminum foil, a copper foil or the like may be used.

As for the electrode active material layer, the above description about the electrode active material layer in the percent disclosure can be referred to.

The solid electrolyte layer contains the solid electrolyte, and optionally contains a conduction aid and a binder. Each component contained in the solid electrolyte layer is not particularly limited, as long as the component is ordinarily used in the battery.

### Production of Electrode Active Material Layer

### Electrode Composite Material Slurry Providing Step

Using an ultrasonic homogenizer, 62.5 volume % lithium titanate (Li₄Ti₅O₁₂) particle as the electrode active material, 33.6 volume % solid electrolyte, 1.2 volume % vapor-grown carbon fiber (VGCF) as the conduction aid, 2.0 volume % styrene-butadiene rubber (SBR) binder (Asaprene Y031 manufactured by Asahi Kasei Corporation), 0.7 volume % dispersion material (DISPERBYK-109 manufactured by BYK-Chemie Japan), and tetralin as the dispersion medium were mixed, so that the electrode composite material slurry was obtained.

### Preparatory Electrode Active Material Layer Forming Step

An aluminum foil as a current collecting foil was coated with the electrode composite material slurry by die coating, so that the preparatory electrode active material layer was formed.

### First Drying Step

### Comparative Example 1

The obtained preparatory electrode active material layer was dried in a drying furnace at 100° C., so that a preparatory electrode active material layer after the first drying step in a comparative example 1 was obtained. As described later, a crack was generated on this preparatory electrode active material layer, and therefore, the second drying step was not executed.

### Comparative Example 2

The obtained preparatory electrode active material layer was dried in the drying furnace at 60° C. for a 1 minute, and thereafter, was dried at 120° C. for 1 minute.

### Second Drying Step

Furthermore, additional drying was executed at 130° C. for 2 minutes, so that an electrode active material layer in a comparative example 2 was obtained.

### Examples 1 and 2

Electrode active material layers in examples 1 and 2 were obtained in the same way as the comparative example 2, except that the temperature in the second drying step was 150° C. (example 1) or 170° C. (example 2).

### Evaluation

### Observation of External Appearance of Preparatory Electrode Active Material Layer After First Drying Step

The external appearance of the preparatory electrode active material layer after the first drying step in each example was visually observed.

### Evaluation of SEM Image

### Sample Production

As the electrode active material layers in the comparative example 2 and the examples 1 and 2, electrode active material layers laminated on the current collectors and electrode active material layers peeled from the current collectors using a tape were prepared, and were transferred into a vacuum electron staining device (VSC4TWDH manufactured by Filgen, Inc.). After the interior of the vacuum electron staining device was vacuumized, a chamber was opened, and osmium (Os) staining was performed for the respective films, while the staining time, the gas concentration and the like were adjusted.

### SEM Image Acquisition

After the Os staining, the electrode active material layer in each example was cut to an appropriate size under inert atmosphere, and thereafter, section processing was performed under cooling condition and vacuum with an air non-exposure holder, using an ion milling device (IM4000PLUS manufactured by Hitachi High-Tech Corporation). After the section processing, the electrode active material layer in each example was introduced into a field emission scanning electron microscope (FE-SEM) (Regulus SU8230 manufactured by Hitachi High-Tech Corporation), while the vacuum atmosphere was kept, and the SEM observation of a secondary electron image and a reflection electron image was performed. Specifically, five SEM images different in observation position were acquired at an observation magnification of 20000 times.

### SEM Image Analysis

The acquired SEM image was captured and quantified by image processing software (ImageJ). Digital image data had a matrix form corresponding to the SEM image of the electrode active material layer, and a numerical value was assigned to each pixel. The numerical value was shown as a tonal scale of 256, which is the eighth power of 2, for an 8-bit display, and was an integer value of 0 to 255. The numerical value was binarized by adopting 220 as a threshold. That is, it was determined that a white portion was the binder, portions other than the binder were expressed as “0”, and the binder was expressed as “1”. Then, the ratio of portions on the binarized image that were expressed as “1” to the whole image was evaluated, and thereby, the binder area fraction was calculated. This analysis was executed for both of the solid electrolyte layer side and the current collector side of the electrode active material layer. The calculated binder area fraction of the solid electrolyte layer side was divided by the binder area fraction of the current collector side. Thereby, the ratio of the binder area fraction of the solid electrolyte layer side to the binder area fraction of the current collector side was calculated. Each binder area fraction was an average value that was calculated based on the five SEM images different in the observation position on the surface of the electrode active material layer.

### Evaluation of Section SEM Image

A section SEM image of a laminated body constituted by the current collector, the electrode active material layer, and the solid electrolyte layer was acquired by the above FE-SEM, and whether peeling occurred between the electrode active material layer and the solid electrolyte layer was confirmed.

### Observation of External Appearance of Solid Electrolyte Layer

The external appearances of solid electrolyte layers in which the solid electrolyte slurry was formed on the electrode active material layers in the comparative example 2 and the examples 1 and 2 by coating were visually observed.

### Result

### Observation of External Appearance of Preparatory Electrode Active Material Layer After First Drying Step

The crack was not generated on the preparatory electrode active material layers in the comparative example 2 and the examples 1 and 2 that were dried at the temperature lower than 100° C. in the first drying step. However, the crack was generated on the preparatory electrode active material layer in the comparative example 1 that was dried at 100° C.

### Evaluation of SEM Image

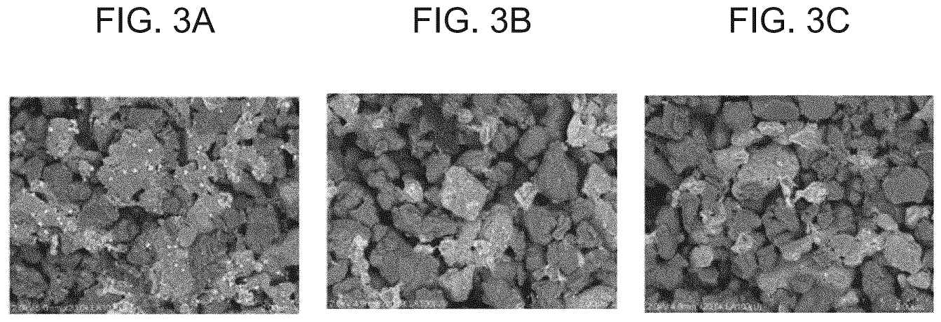

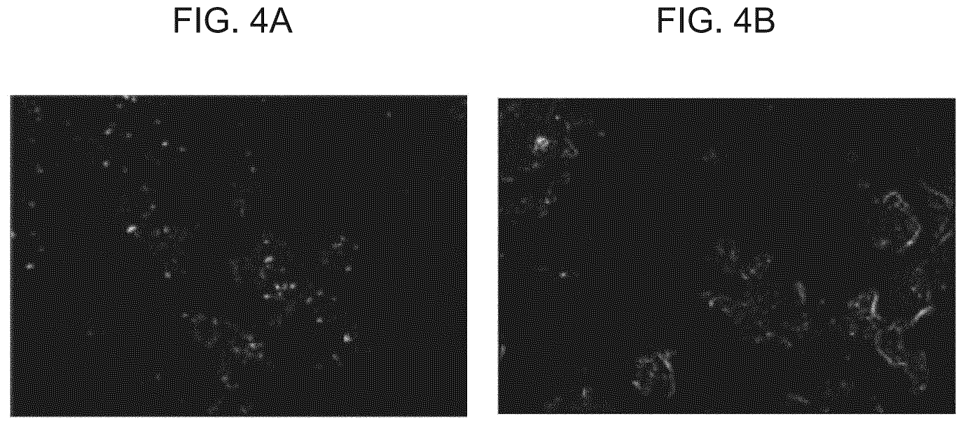

FIG. 2 shows a graph showing the binder area fraction of the solid electrolyte layer side and the binder area fraction of the current collector side about the comparative example 2 and the examples 1 and 2. Further, Table 1 shows the ratio of the binder area fraction of the solid electrolyte layer side to the binder area fraction of the current collector side and the ratio of the binder area fraction of the solid electrolyte layer side to the binder volume fraction in the above examples. Furthermore, FIG. 3A, FIG. 3B and FIG. 3C show SEM images of the electrode active material layers in the above examples. FIG. 3A shows a SEM image in the comparative example 2, FIG. 3B shows a SEM image in the example 1, and FIG. 3C shows a SEM image in the example 2. Further, FIG. 4A and FIG. 4B show binarized images of acquired SEM images. FIG. 4A shows an image in the comparative example 2, and FIG. 4B shows an image in the example 2.

TABLE 1

| | Binder Area Fraction | |
|---|---|---|
| | of Solid Electrolyte | Binder Area Fraction |
| | Layer Side/Binder | of Solid Electrolyte |
| | Area Fraction of Current | Layer Side/Binder |
| | Collector Side [area %] | Volume Fraction [%] |
| Comparative | 49 | 20 |
| Example 2 | | |
| Example 1 | 60 | 32 |
| Example 2 | 89 | 50 |

As shown in FIG. 2 and Table 1, in the electrode active material layers in the examples in each of which the temperature in the second drying step at the time of the production was higher compared to the electrode active material layer in the comparative example 2, the ratio of the binder area fraction of the solid electrolyte layer side to the binder area fraction of the current collector side was large, and particularly, this ratio was further large in the example 2 in which the temperature in the second drying step was highest. That is, in the electrode active material layers in the examples, the spread of the binder on the solid electrolyte layer side was larger than in the electrode active material layer in the comparative example.

Further, as shown in Table 1, in the electrode active material layers in the examples in each of which the temperature in the second drying step at the time of the production was higher compared to the electrode active material layer in the comparative example 2, the ratio of the binder area fraction of the solid electrolyte layer side to the binder volume fraction was also large, and particularly, this ratio was further large in the example 2 in which the temperature in the second drying step was highest. Further, as shown in FIG. 3A and FIG. 4A, the binder in the electrode active material layer in the comparative example 2 existed in a point manner, and on the other hand, as shown in FIG. 3B, FIG. 3C, FIG. 4B, the binder in the electrode active material layer in each example existed in a planar manner. The reason is thought to be because the viscosity of the binder decreased and the binder extended and spread on the solid electrolyte layer side, in the electrode active material layer in each example in which the preparatory electrode active material layer was dried at a higher temperature.

### Evaluation of Section SEM Image

In the laminated body in the comparative example 2, the peeling between the electrode active material layer and the solid electrolyte layer was confirmed. On the other hand, in the laminated body in the example 1, the peeling was not confirmed. The result of the evaluation is not illustrated.

### Observation of External Appearance of Solid Electrolyte Layer

On the electrode active material layer in each example, a portion where the solid electrolyte layer was not formed was hardly confirmed. On the other hand, on the electrode active material layer in the comparative example 2, many portions where the solid electrolyte layer was not formed were confirmed.

The above result shows that the spread of the binder on the solid electrolyte layer side of the electrode active material layer and the ease of the formation of the solid electrolyte layer on the electrode active material layer are associated with each other.

What is claimed is:

1. An electrode active material layer for a solid-state battery, the electrode active material layer being interposed between a current collector and a solid electrolyte layer,
the electrode active material layer containing an electrode active material and a binder, wherein
a ratio of a binder area fraction of a side of the solid electrolyte layer to a binder area fraction of a side of the current collector is 55 area % or more.

2. The electrode active material layer according to claim 1, wherein a ratio of the binder area fraction of the side of the solid electrolyte layer to a binder volume fraction is 30% or more.

3. The electrode active material layer according to claim 1, wherein the binder is a styrene-butadiene rubber binder.

4. A solid-state battery comprising:
a current collector;
a solid electrolyte layer; and
the electrode active material layer according to claim 1, the electrode active material layer being interposed between the current collector and the solid electrolyte layer.

5. A production method for the electrode active material layer according to claim 1, the production method comprising:
(a) providing an electrode composite material slurry that contains the electrode active material, the binder, and a dispersion medium;
(b) forming a preparatory electrode active material layer by coating the current collector with the slurry;
(c) drying the preparatory electrode active material layer at a temperature lower than 100° C.; and
(d) further drying the preparatory electrode active material layer dried at the temperature lower than 100° C., at a temperature of 140° C. or higher.
